(19) United States
(12) Patent Application Publication
(10) Pub. No.: US 2019/0387363 A1
(43) Pub. Date: Dec. 19, 2019

(54) Luggage Tracking Device Systems And Methods

(71) Applicant: Olumuyiwa Victor Adedamola Olufosoye, Cumming, GA (US)

(72) Inventor: Olumuyiwa Victor Adedamola Olufosoye, Cumming, GA (US)

(21) Appl. No.: 16/438,486

(22) Filed: Jun. 12, 2019

Related U.S. Application Data
(60) Provisional application No. 62/685,305, filed on Jun. 15, 2018.

(51) Int. Cl. H04W 4/029; H04W 4/35; H04W 4/80; H04W 4/024

(52) U.S. Cl. CPC H04W 4/029; H04W 4/024; H04W 4/80; H04W 4/35

(57) ABSTRACT

The present invention is a tracking application for luggage, cars or any trackable items or objects within a given proximity. All the versions of the application make use of a mobile telephone device or a wearable device to receive signals from existing tracker beacons and also makes use of existing components of a wireless telephone system, for example, by using the Bluetooth capabilities of a mobile telephone handset to receive signals from the tracker beacon. The app includes an audio output, such as a speaker for presenting the received information. The app also includes storage for a unique identification of the tracker beacon device.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### Field of the Invention

The present invention relates to luggage tracking and monitoring devices, systems and methods.

### Description of the Related Art

Misplaced luggage is a growing problem in the travel industry. The increasing volume of air traffic and the increasing congestion in airports contribute to flight delays and misplaced luggage. Although adhesive paper tags bearing the intended destination of a passenger's luggage have been used for decades, luggage is often misplaced and mishandled. Air travelers worry whether their luggage will arrive at their intended destination and often have to extend their time at baggage carousels while waiting for luggage that may not arrive. This is a particularly pressing problem for business travelers whose luggage may contain time sensitive materials.

In addition, even with increased security measures at airports, there still exists a chance that an item of luggage may end up in an aircraft which is not transporting the corresponding passenger. Alternatively, a passenger may enter an aircraft and his or her luggage may not be in that aircraft. If luggage is misplaced, the luggage may end up at a different location than the passenger's intended destination resulting in unsatisfied passengers and increased costs for the airline to deliver the luggage to its correct destination.

Traditional luggage identification systems suffer from deficiencies inherent in their structure. Printed paper tags attached by adhesives during check-in require inspection by security personnel, which is both time-consuming and prone to human error. Bar codes and other forms of optical identification used by airports are also prone to error. Each item of luggage must be individually scanned and such scanning does not guarantee that the luggage will be placed on the correct aircraft. Further, these paper tags are flimsy and may fall off or be torn off resulting in misrouted luggage.

Several systems have been implemented to remedy the problem of lost or misplaced bags. U.S. Pat. No. 5,576,692 describes a system for tracking luggage where a beeper device is attached to an article of luggage. If luggage is misplaced, a user calls a number associated with the beeper. The call causes the beeper to emit a sound alerting airline personnel in the immediate vicinity to the presence of the misplaced luggage. Airline personnel may subsequently contact the user and provide the user with the location of the misplaced luggage. This system, however, requires airline personnel to be vigilant in locating the misplaced baggage. Moreover, if no personnel are in the vicinity of the luggage, the luggage cannot be rerouted to its intended destination.

U.S. Pat. No. 7,199,712, describes an RFID system that can be used to identify the position of a passenger or their luggage in an aircraft. In this system, an RFID tag is placed on a passenger's ticket and RFID labels are attached to the passenger's luggage. A network of .RF1D readers is positioned inside the cabin of an aircraft and can be used to determine the location of luggage and the passenger. The system is limited inasmuch as the readers must be relatively close to the corresponding tag for the system to work.

However, to Applicant's knowledge, none of these prior art methods have been found to be completely suitable to meet these needs and are cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

A tracking application for tracking luggage, cars or any trackable items or objects within a given proximity. All the versions of the application make use of a mobile telephone device or a wearable device to receive signals from existing tracker beacons that was purchased in bulk from a third-party company.

In order to solve the above problems, the present invention relates to an application to initially support mainly Android and IOS mobile platforms. The application will need to receive signal from a beacon device.

The app is a tracker that will receive signal from the beacon through the Bluetooth technology and once the signal is received it will announce the distance of the beacon and will also vibrate on the mobile phone. This app for tracking is mainly focused on tracking luggage or cars for now but new embodiments are possible later.

The present invention provides for a novel and improved system and method for identifying luggage which is extremely versatile and conformable for use in combination with existing luggage identification systems and in a way such as to enable continuous identification during all stages of the movement and transfer of luggage at various transportation facilities.

The present invention provides a visible GPS locator to show path to a point where signals is being received from SLP beacon.

The owner claim rights only to track luggage within airports with a beacon technology

Numerous other embodiments are also possible.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 100 is an exemplary embodiment of the proposed invention luggage tracker.

FIG. 200 is an exemplary embodiment of the beacon technology.

FIG. 300 shows luggage tracker access to other services.

FIG. 400 option to open or uninstall the app.

FIG. 500 shows the login page.

FIG. 600 shows members registration page.

FIG. 700 shows luggage tracker services.

FIG. 800 shows multiple functionalities of the app.

FIG. 900 shows tracking page of the app.

FIG. 1000 shows another view of the tracking page.

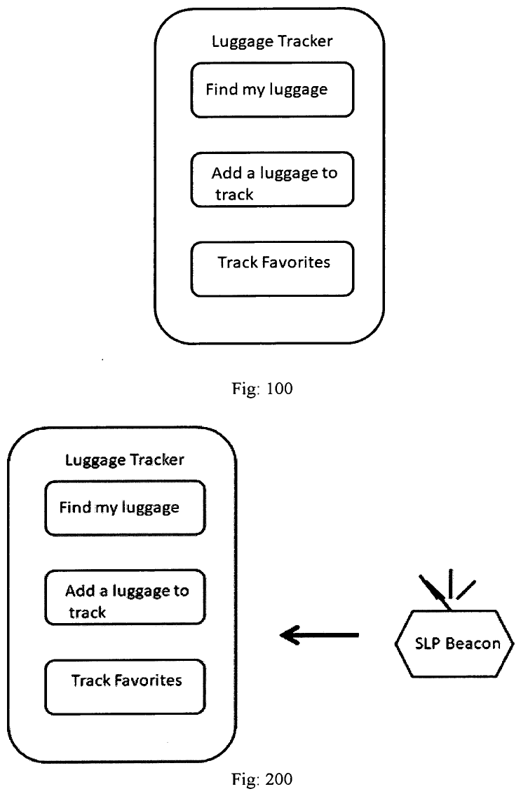

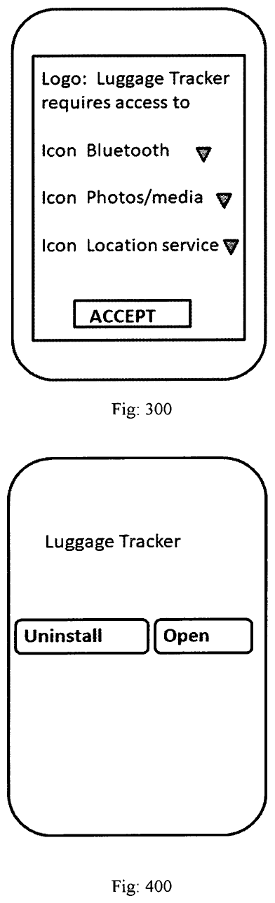

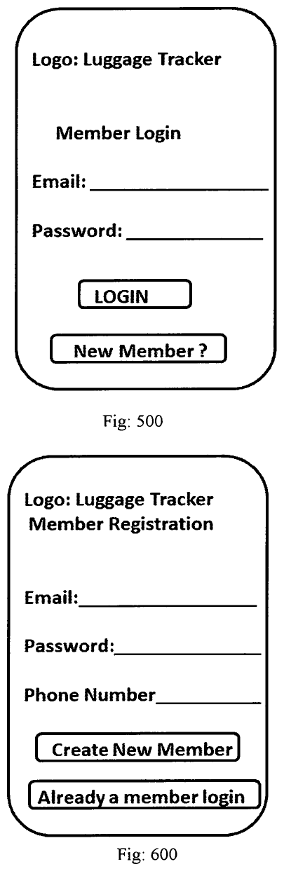

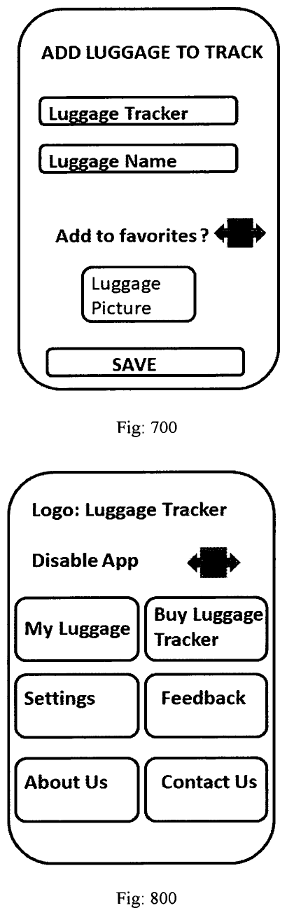

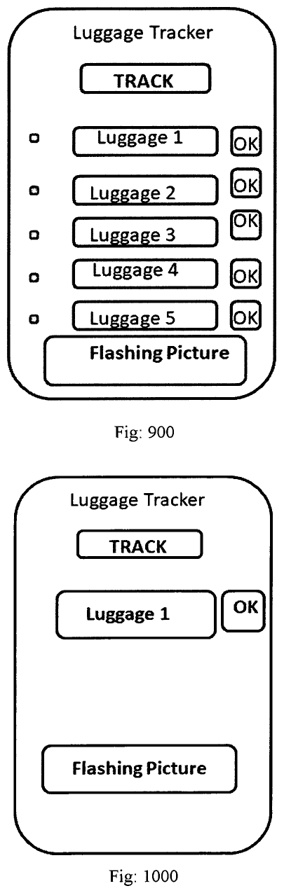

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

An application for tracking luggage, cars or any item or objects within a given proximity. All the versions of the application make use of a mobile telephone device or a wearable device to receive signals from existing tracker beacons that was purchased in bulk from a third-party company. In-addition application makes use of existing components of a wireless telephone system, for example, by using the Bluetooth capabilities of a mobile telephone handset to receive signals from the tracker beacon. The application includes a code that will receive distance signals from where the tracker beacon is located and relate it back to the wireless communication device through the app. The app also includes an audio output, such as a speaker for presenting the received information. The app also includes storage for a unique identification of the tracker beacon device. This identification is passed to the remote server through the application on any wireless communication device that runs on IOS or Android Platforms. Another version of the system provides both autonomous and client-server-based navigation services in which a removable database supports route planning in a limited area and a remote server supports route planning outside that area.

Various example embodiments of the present general inventive concept, as described herein, provide a luggage tracking device that is attachable to a piece of luggage and may be linked to a mobile device and/or computer to provide a user with real time or periodic updates as to the current location of the luggage. GPS technology may be employed to determine the location information, which gives the traveler confidence and improves the traveling experience by eliminating the stress of losing luggage.

This invention is based on creating an application to initially support mainly Android and IOS mobile platforms. The application will need to receive signal from a beacon device. The app is a tracker that will receive signal from the beacon through the Bluetooth technology and once the signal is received it will announce the distance of the beacon and will also vibrate on the mobile phone.

The patent holder will be the sole owner for right to use the third-party beacon for tracking purpose and for any other type of tracking. In this case, its luggage but we will advance to adding further type of tracking systems with time so we are not limited on scope. The beacon by the third party is normally used for different configurations, some use it for alerting, some for store info, some for discount information but we pioneered the use for tracking which is the unique concept.

It is noted that the simplified diagrams and drawings do not illustrate all the various connections and assemblies of the various components, however, those skilled in the art will understand how to implement such connections and assemblies, based on the illustrated components, figures, and descriptions provided herein, using sound engineering judgment.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) an application to initially support mobile platforms which will receive signal from a beacon device a visible GPS locator to show path to a point where signals is being received from SLP beacon.

2) The app is a tracker that will receive signal from the beacon through the Bluetooth technology and once the signal is received it will announce the distance of the beacon and will also vibrate on the mobile phone.

3) The app also includes an audio output, such as a speaker for presenting the received information. The app also includes storage for a unique identification of the tracker beacon device.
